(19) United States
(12) Patent Application Publication
(10) Pub. No.: US 2011/0079404 A1
(43) Pub. Date: Apr. 7, 2011

(54) Digging Tool and Method of Using the Same

(76) Inventor: Gwyneth Christine Pett, Altadena, CA (US)

(21) Appl. No.: 12/996,993

(22) PCT Filed: Jun. 11, 2009
(86) PCT No.: PCT/US09/47113

§ 371 Date: Dec. 9, 2010

Related U.S. Application Data
(60) Provisional application No. 61/131,771, filed on Jun. 11, 2008.

(51) Int. Cl. A01B 33/06; A01B 79/00

(52) U.S. Cl. 172/1; 172/765

(57) ABSTRACT

A digging tool has a shaft with a proximal end and a distal end. The proximal end has at least one beveled surface for engaging with a drill chuck. An eggbeater-shaped digging body is coupled to the shaft. The digging body is formed from a plurality of bands that intersect each other at an intersection region at the distal end of the shaft. The bands are welded to each other and to the shaft at the intersection region and form a plurality of substantially U-shaped digging surfaces. Each U-shaped digging surface has a distal arm coupled to the intersection region and a proximal arm coupled to the shaft between the intersection region and the proximal end of the shaft. A protective cover is welded to the intersection region to cover the intersection region. The protective cover preferably includes a distally extending non-puncturing tip.

### CROSS-REFERENCE TO RELATED APPLICATIONS

This application claims the benefit of U.S. Provisional Application 61/131,771 filed on Jun. 11, 2008.

### FIELD OF THE INVENTION

The present invention relates generally to digging tools. More specifically, the present invention discloses an egg-beater shaped digging tool.

### BACKGROUND OF THE INVENTION

Various digging tools useable, for example, for gardening purposes are known in the art. Many of these tools primarily involve the use of the following design techniques either alone or in conjunction with another technique: (1) an Archimedes screw or auger design; (2) a helical, flighting, leading tool head; (3) a pilot point for entry into the soil; (4) dual spurs, blades, serrated edges or fins; (5) pointed spurs, blades or fins; and/or (6) sharpened spurs, blades or fins.

Each of these design details allows for at last one of the following undesirable outcomes: (1) rotational imbalance upon contact and entry into the soil; (2) entanglement in roots, irrigation tubes, electric cables and conduit; (3) possible puncturing of piping, tubing and plant bulbs; and (4) scraping, slicing or damaging of body parts and other valuable amenities that may inadvertently come into contact with the moving and drilling portion of the tool.

Previous technologies, such as the auger design, though powerful, suffer from the above-indicated draw backs. For example, the spiral action of the auger's digging head has a tendency to entangle underground objects such as roots, irrigation tubing as well as lighting and irrigation cables. The sharp tip of the auger can puncture pots, plastic sprinkler piping and electrical conduit, leading to leaks and shorted systems. The spiral design tends to coil around objects causing a rotational imbalance, drill body kick back and an entangled digging component.

As indicated above, the spiral design of the auger typically tangles and traps wires and lines that may lie beneath the surface being worked or tilled and acts to pull the drill body and the handler toward the work surface and the entrapped objects. The original auger design is a suitable tool for large-scale digging, when managed by an experienced handler. The spiral design typically requires two-handed manipulation of the tool and involves the negative features of underground object entwinement, drill body kickback, and potential stripping, shredding and/or puncturing of valuable cables, conduit, tubing and piping.

Accordingly, there is an immediate need for an improved non-invasive digging tool.

### SUMMARY OF THE INVENTION

Various embodiment digging tools overcome the inherent problems of the existing prior art tools, and in particular auger tools, by eliminating the spiral design of the digging body. Embodiment digging tools provide sturdy and compact devices for all potential users, both professional and private.

Various embodiment digging tools comprise a shaft having a proximal end and a distal end. The proximal end has at least one beveled surface for engaging with a drill chuck. Preferably, the proximal end has three beveled surfaces. An eggbeater-shaped digging body is coupled to the shaft. The digging body is formed from a plurality of bands that intersect each other at an intersection region at the distal end of the shaft. The bands are coupled, preferably welded, to each other and/or the central shaft at the intersection region and form a plurality of substantially U-shaped digging surfaces. Each U-shaped digging surface has a distal arm coupled to the intersection region and a proximal arm coupled to the shaft between the intersection region and the proximal end of the shaft. A protective cover or button-like weld is welded to the intersection region to cover the intersection region. In particularly preferred embodiments the radial extension of the distal arms from the shaft is less than the radial extension of the proximal arms from the shaft.

The embodiment digging tools are safe and suitable for a variety of people from ages four to adult, and are particularly useful for people of limited strength and mobility when the use of a hand trowel requires too much wrist, arm and shoulder motion. Embodiment digging tools are excellently suited for use in compact areas such as pots, rock gardens, borders, and existing bedding areas due to its minimally invasive positioning and working of the soil. These advantages and others shall be more particularly set forth in the following detailed description.

### BRIEF DESCRIPTION OF THE DRAWINGS

FIG. 1 is perspective view of an embodiment digging tool.

FIG. 2 is a detailed view of a proximal end of a shaft of an embodiment digging tool.

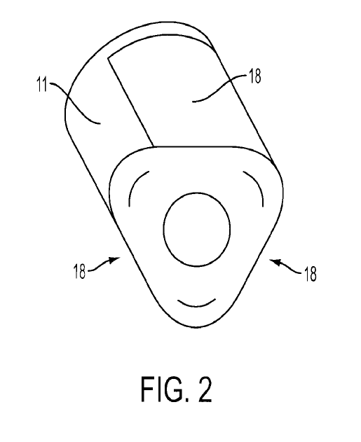

FIG. 3 is a perspective view of another embodiment digging tool.

FIG. 4 is a perspective view of yet another embodiment digging tool.

FIG. 5 is a perspective view of a further embodiment digging tool.

### DETAILED DESCRIPTION

Various embodiment digging tools have been developed for use in home and professional gardening among other applications. A digging tool is provided that allows for fast digging of earthen material. With an embodiment digging tool, the inventor was able to install 96 impatiens in under six minutes. Numerous one and two gallon plants were also installed with the same tool. Patio pots were refreshed with new color and minimal soil spillage in the process. Dead brown/orange patches of grass left from dog urine damage were scarified leaving the areas less noticeable and ready to grow back. The digging tool in an exemplary embodiment is an eggbeater-like tool, mounted in a hand-held drill or other similar device capable of imparting rotational motion to the tool, which may be cordless or otherwise (collectively or individually hereinafter referred to as a “drill”).

In another exemplary embodiment, smaller eggbeaters may be mounted on a drill and used for such excavations. Though an effective digging tool, there are some drawbacks to the use of the kitchen grade beaters. Firstly, the length of the digging body and central shaft may not be adequate. To improve on this embodiment, in an exemplary embodiment, an elongated eggbeater with a widened main body by as much as 3 inches in both length and width was used with success.

Secondly, the material strength of a kitchen quality eggbeater may be inadequate. In another exemplary embodiment the inventor used ⅜ inch×⅛ inch heat-treated American steel mounted on a ⅜ inch tubular central shaft to form the eggbeater. This also proved to be very successful. Thirdly, a kitchen eggbeater utilizes a pivotal point at the intersection of the blades that may be a weak spot. To overcome this problem in an exemplary embodiment, the inventor spot-welded that site for added strength and eliminated the occurrence of the blades collapsing, twisting, and pivoting. Lastly, a kitchen eggbeater may not remain in the chuck under drilling pressure due to the smooth end of the shaft. To overcome this problem, the inventor beveled the tip of the shaft into a triangular cut in cross-section to insure an inseparable grip while in use. In another exemplary embodiment, the shaft may be cut in other cross-sectional shapes that would allow for suitable and durable gripping by a chuck of the drill.

Also tested, were 12, 14.4, 18 and 19.2 volt battery-operated drills for the procedure. It was decided that the 14.4 volt drill was the minimum strength best suited for the drilling task for planting and the 18 volt tool was the best suited for digging trials. From there it was determined that the design/concept had phenomenal possibilities for both home and professional garden applications.

Preferred embodiment digging tools use an eggbeater much like the ones used in a kitchen hand mixer but with welded steel blades that are rounded at the top and bottom of the digging body. The blades are joined by a durable protective button-like spot weld for thousands of uses in planting, scarifying, light blending and tilling of the soil.

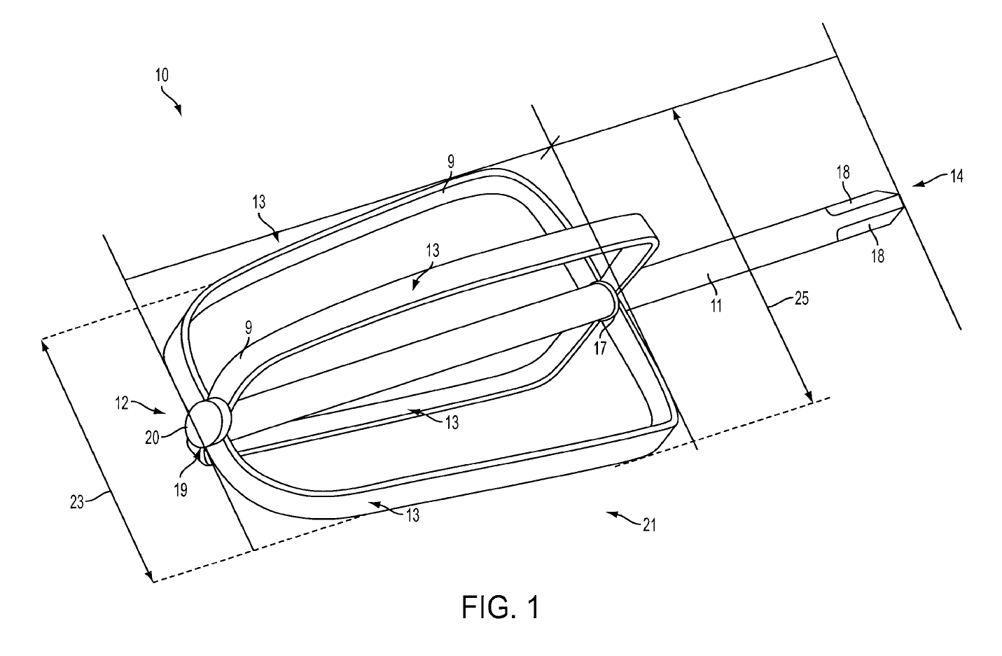

In an exemplary embodiment 10 of the invention shown in FIG. 1, a rigid, ⅛ inch thick, flat steel, band-like material is used to form the U-shaped digging blades 13 which define the main digging body 21 of the tool 10. The digging body 21 is coupled to a shaft 11 having a distal end 12 and a proximal end 14, in which the term “distal” indicates that direction or end which is furthest from the operator of the digging tool 10 while in use, while “proximal” means that end or direction which is closest to the operator of the tool 10 while in use. An exemplary material 9 is a metallic material, such as steel, and is preferably ⅛ inch thick for durability. In preferred embodiments, each of the metal band components 9 on the digging body 21 measures about 6⅝ inches in length. Such a length allows an overall digging body 21 length of 4½ inches having a distal diameter 23 of about 2½ inches and a proximal diameter of about 4 inches. In preferred embodiments the bands 9 converge at the intersection region 19 and are welded beneath a ⅛ inch thick button-like protective cover 20 to the distal end of the ⅜ inch central shaft 11. The bands 9 form a plurality of substantially U-shaped digging surfaces 13. The separate, steel protective cover 20 welded to the intersection region 19 protects the blades 13 from excess wear while spinning in the soil. Alternatively, the protective cover 20 may be provided by a spot weld. Hence, in some embodiments the protective cover 20 for the intersection region 19 may be provided by a separate, button-like metal plate that is welded onto the intersection region 19, whereas in other embodiments the protective cover 20 is provided by a button-like spot weld. The straps 9 may be molded over a buck for the optimal shaping of the digging body 21, which is preferably slightly tapered, such that it is narrower at distal end 12 where the tool 10 enters the soil. That is, the distal arms of the U-shaped digging surfaces 13, which are welded to the intersection region 19, have smaller diameters than those of the corresponding proximal arms, which are welded to the shaft 11 between the intersection region 19 and the proximal end 14. This tapered design allows for less roving and undesirable movement of the digging body 21 while in its rotary operation mode. The proximal ends of the bands 9, which form the proximal arms of the U-shaped digging surfaces 13, are, for example, spot welded at each juncture 17 of the shaft 11 leaving, for example, 5½ inches of the shaft 11 exposed. 1½ inches of the termination point on this remaining 5½ inches of the proximal end 14 of the shaft 11 is machined to a triangular formation to provide optimal gripping in the chuck of the drill. Consequently, in preferred embodiments, the proximal end 14 of the shaft 11 includes 3 beveled surfaces 18 that are adapted to engage with the drill chuck.

Tool 10 illustrates exemplary dimensions of the digging body 21, the central rod-shaped shaft 11 (with triangular chuck-grip), as well as the two exemplary shaft 11 lengths of 11 inches and 26 inches overall. Other shaft 11 lengths may also be used. By using longer shafts 11, a user can dig without having to bend and/or kneel as much. With the shown exemplary embodiment 10 only four U-shaped digging blades 13 are used, which are defined by the strips 9 of band material; in other embodiments more or less than four digging surfaces 13 may be used. However, as the number of blades 13 used increases, it may become more difficult to dislodge trapped soil, stones and other material from the tool 10 that lodge in the space surrounded by the U-shaped blades 13. The bit end 14 is triangulated to ensure a secure connection into the chuck of any hand held drilling tool. Steel straps 9 placed perpendicularly, are spot welded at the intersection region 19 for durability beneath the protective button-like cover or weld 20 and at the trailing end of the digging portion 21 of the tool 10 along the steel shaft 11, which may be twice the length of the digging blades 13 of the tool, creating a durable beater-like device. As the leading, distal segment 12 of the tool 10 contacts the soil, the rotary motion penetrates the surface, moving, blending, aerating, softening and lifting the soil, leaving a perfect planting hole. The protective button-like weld site or cover 20 welded at the entry point 12 of the inventive digging tool creates a sturdy, impenetrable barrier to minimize wearing and breakdown of the tool head after multiple contacts with the soil. Both tapering (i.e., embodiments in which the radial extensions of the distal and proximal arms of the U-shaped digging surfaces are unequal) and cylindrical embodiments (i.e., embodiments in which the radial extensions of the distal and proximal arms of the U-shaped digging surfaces are equal) of the digging tool allow for uniform and balanced penetration of the surface of the soil. Additionally, the tapering embodiment 10 serves as a pilot for the entry of the tool 10 into the soil.

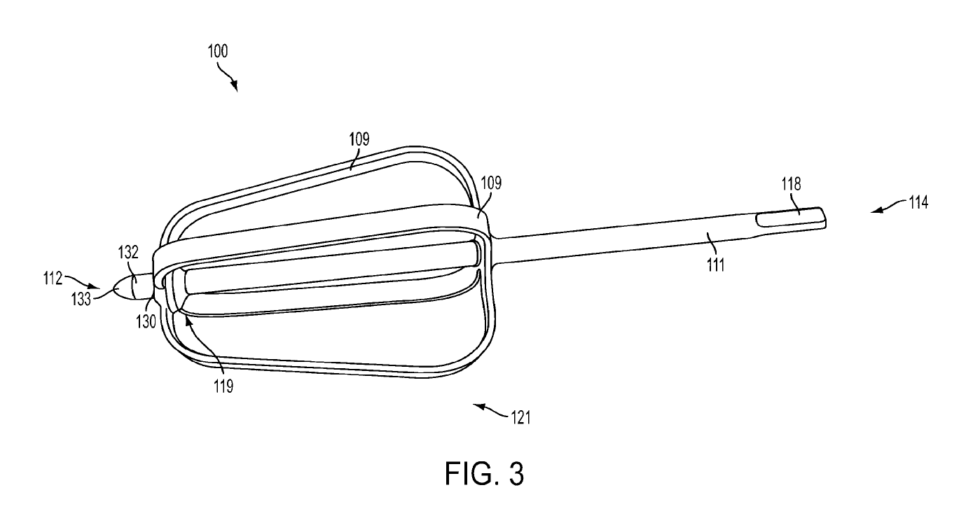

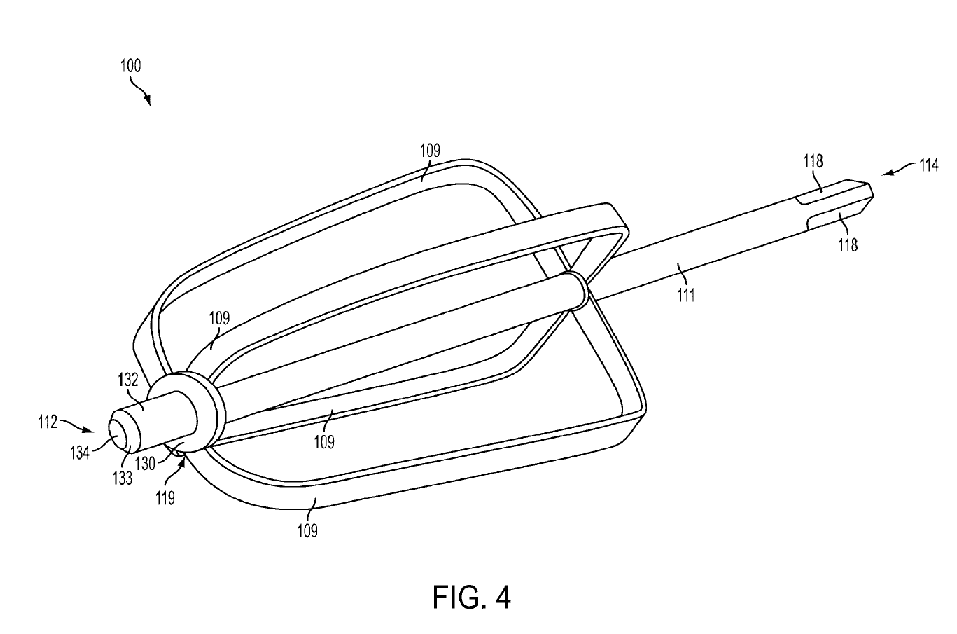

Another embodiment digging tool 100 is depicted in FIG. 3. As shown in FIG. 3, the digging tool 100 includes an eggbeater-like main body 121 formed of metal bands 109, the proximal ends of which are welded to a central shaft 111. The proximal end 114 of shaft 111 includes a beveled surface 118, and preferably three beveled surfaces, for mating engagement with a drill chuck. The steel bands 109 cross or join at intersection region 119, which is capped with a button-like protective cover 130 on the distal side 112 of intersection region 119. More specifically, the bands 109 may be welded to each other, and then at least one of the bands 109 welded to the distal end 112 of shaft 111. The protective cover 130 is welded to the distal side 112 of intersection region 119 to protect the intersection region 119 when digging. Further, the protective cover 130 includes a tapered tip 132 that extends distally from the protective cover 130 and which may aid in the penetration of the main body 121 into soil and stabilize the tool 100 while digging. The tapered tip 132 is not sharp, but rather has a smooth/rounded surface 133. This rounded surface 133 is designed to be a non-puncturing surface so as to prevent puncturing or damage to roots, bulbs, cables, tubing, pots, conduit, pipes or landscape fabrics. As indicated in FIG. 3, to enhance the structural integrity of the intersection region 119, another button or protective cap may optionally be welded to the proximal side 114 of the intersection region 119, in effect sandwiching the intersection region 119 between two protective covers. As shown in FIG. 4, in some embodiments the non-puncturing tip 132 may be provided by beveled or rounded edges 133 of a planar end surface 134 of the cylindrical steel rod 132 extending from a single protective cover 130 welded to the distal side 112 of intersection region 119.

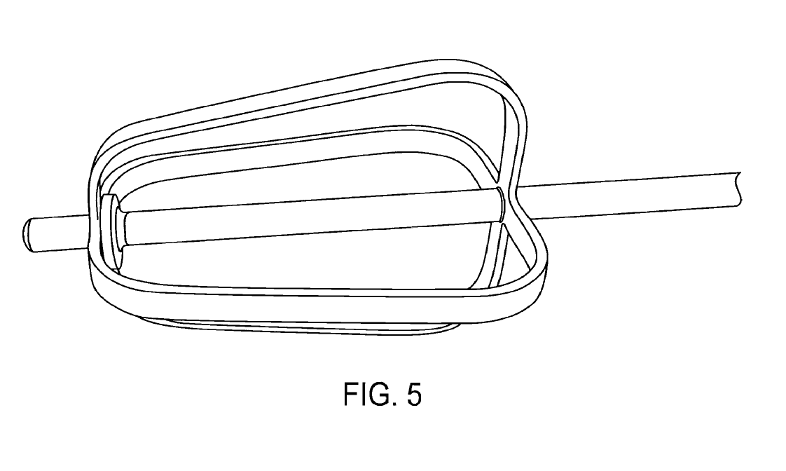

In a preferred embodiment, the central steel shaft extends axially through the converging steel bands at the intersection region. In such embodiments, then, a non-puncturing tip extending distally from the intersection region is provided by the shaft to which the main body is bonded. For such embodiments, the bands 9, 109 and the protective cover 20, 130 each include a hole or gap sized to accept the shaft 11, 111. These holes or gaps are in register with each other at the intersection region 19, 119 and the shaft 11, 111 then passes through these holes or gaps at the intersection region 19, 119 to extend distally to provide the non-puncturing tip. In preferred embodiments, the non-puncturing tip as a contiguous part of the main shaft 11 extends distally by about ⅜ of an inch from the intersection region. In certain of these embodiments the protective cover 20, 130 is not required, as the shaft 11, 111 passing through the bands may provide sufficient mechanical strength for the distal end of the main body. As indicated in FIG. 5, the central shaft may pass through respective openings in both the proximal and distal ends of the bands that form the main body. In yet other embodiments, including those that have no non-puncturing tip, the protective cover 130 may have the shape of a washer and be welded to the proximal side of the intersection region, with the shaft passing through the opening of the protective cover. Examples of such protective cover placement are shown in FIGS. 3 and 5.

Advantages of the embodiment digging tools include:

1. Expedite layout and installation of bedding, border and color plantings up to 8 inch pot size. Use of an embodiment digging tool expedites the proper blending of soil, arranging and planting of bedding and potting plants for efficient installation.

2. Provide single-handed, non-invasive digging, scarifying, and small scale tilling for compact areas not accessible to a larger tool. The tools are excellent implements for planting in compact areas, hillsides and terraces. The embodiment tools efficiently dig and blend soil for bulbs and bedding plants up to a two gallon pot size and are suitable in exemplary embodiments for digging holes up to 8″ deep and wide. The distal and proximal ends of the digging portion of embodiment digging tools attach to a single steel shaft operating on the rotational flight motion to loosen and move the soil.

3. The beater-like design of the exemplary embodiment digging tools embody a minimally invasive concept and do not entangle, cut, slice, puncture or separate cables, connections, pipes, tubing, existing plants or other similar obstacles. The tools do not damage surrounding roots, bulbs, cables, tubing, pots, conduit, pipes or landscape fabrics. In various embodiments, the lack of a pilot point eliminates entanglement, punctures, shattering and like damage to obscured underground objects.

4. Minimize bending and kneeling for knee and back pain sufferers, offering a therapeutic method for the enjoyment of garden-related tasks. A primary safety function of the non-auger style design of the exemplary embodiment digging tools serves to eliminate rotational imbalance during the advance into the soil, causing the operator to be drawn forward toward the working surface. The single handed use of the drilling tool and an embodiment digging tool allows the operator to use their free hand to remove loosened soil and install the plant into the prepared hole.

5. Allow efficient installation capabilities for existing cactus, rock, vegetable, and planter gardens.

6. The lightweight design allows for longer run times and less stress and drain on the battery operated drilling tool. That translates to more plantings between battery charging times. The embodiment digging tools are versatile, rotary powered, garden digging implements attachable to any hand-held drill, whether battery or electrically operated. In various embodiments, the triangular terminal point of the central shaft segment chucks securely into the hand held drill. The embodiment digging tools provide a convenient gardening method, in which the tool is attached to a drill, the drill is activated to impart rotation to the digging tool, and then the distal end of the rotating digging tool is contacted and advanced into soil to create a depression or hole. Subsequently, a plant may be settled in the hole or depression, and the soil is advantageously loosened by the digging action of the embodiment digging tool.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the following claims.

What is claimed is:

1. A digging tool comprising:
a shaft comprising a proximal end and a distal end, the proximal end comprising at least one beveled surface adapted for engaging with a rotational drive source;
a digging body coupled to the shaft, the digging body comprising a plurality of bands converging at an intersection region at the distal end of the shaft, the bands coupled to each other and to the shaft at the intersection region and forming a plurality of substantially U-shaped digging surfaces, each U-shaped digging surface having a distal arm coupled to the intersection region and a proximal arm coupled to the shaft between the intersection region and the proximal end of the shaft; and
a protective cover coupled to the intersection region.

2. The digging tool of claim 1 wherein the radial extension of the distal arms from the shaft is less than the radial extension of the proximal arms from the shaft.

3. The digging tool of claim 1 wherein the intersection region comprises at least a weld to weld the bands to each other and to the distal end of the shaft.

4. The digging tool of claim 1 wherein the protective cover is welded to the distal side of the intersection region.

5. The digging tool of claim 4 wherein the protective cover comprises a non-puncturing tip.

6. The digging tool of claim 1 wherein the shaft extends through the intersection region to provide a non-puncturing tip.

7. The digging tool of claim 1 wherein the rotational drive source is a drill and the proximal end of the shaft is adapted to releasably engage with a chuck of the drill.

8. The digging tool of claim 7 wherein the proximal end comprises three beveled surfaces.

9. A gardening method comprising:
imparting rotational motion to a digging tool, the digging tool comprising:
a shaft comprising a proximal end and a distal end, the proximal end comprising at least one beveled surface adapted for engaging with a rotational drive source;
a digging body coupled to the shaft, the digging body comprising a plurality of bands converging at an intersection region at the distal end of the shaft, the bands coupled to each other and to the shaft at the intersection region and forming a plurality of substantially U-shaped digging surfaces, each U-shaped digging surface having a distal arm coupled to the intersection region and a proximal arm coupled to the shaft between the intersection region and the proximal end of the shaft; and
a protective cover coupled to the intersection region to cover the intersection region;
contacting the rotating digging tool with soil; and
advancing the rotating digging tool into the soil to create a depression in the soil.
